(19) United States
(12) Patent Application Publication
(10) Pub. No.: US 2024/0221756 A1
(43) Pub. Date: Jul. 4, 2024

(54) END-TO-END NEUROMORPHIC ACOUSTIC PROCESSING

(71) Applicant: Intel Corporation, Santa Clara, CA (US)

(72) Inventors: Kuba Tomasz Lopatka, Gdansk (PL); Katarzyna J. Kaszuba-Miotke, Gdynia (PL); Karol Jan Polec, Gdansk (PL)

(21) Appl. No.: 18/148,358

(22) Filed: Dec. 29, 2022

(51) Int. Cl. G10L 15/34; G06N 3/063; G10L 15/16; G10L 15/28

(52) U.S. Cl. CPC G10L 15/34; G06N 3/063; G10L 15/16; G10L 15/285

(57) ABSTRACT

A neuromorphic processing device includes a spike generator including hardware to generate a set of input spikes based on acoustic signal data generated by a microphone of a computing device. The neuromorphic processing device further includes a neuromorphic compute block to implement a spiking neural network (SNN), receive the set of input spikes as an input to the SNN, and generate a set of output spikes from the SNN based on the input. A result for an acoustic recognition task may be determined based on the set of output spikes.

### TECHNICAL FIELD

This disclosure relates in general to the field of computer systems and, more particularly, to acoustic recognition processing using microphone data of a computing device.

### BACKGROUND

Acoustic recognition systems, such as speech recognition systems, have become increasingly important in modern computing systems and applications. For instance, more and more computer-based devices use speech recognition to receive commands from a user in order to perform some action as well as to convert speech into text for dictation applications or even hold conversations with a user where information is exchanged in one or both directions. Such systems may be speaker-dependent, where the system is trained by having the user repeat words, or speaker-independent where anyone may provide immediately recognized words. Speech recognition is now considered a fundamental part of mobile computing devices. At the same time, as computing devices become more mobile and adopt smaller form factors, power efficiency and battery life of a device may be strained by advanced acoustic recognition technologies and hardware.

### BRIEF DESCRIPTION OF THE DRAWINGS

FIG. 1 is a simplified block diagram illustrating example interactions of a user with various computing devices utilizing microphones.

FIG. 2 is a simplified block diagram of an example computing device.

FIG. 3A is a simplified block diagram illustrating an example neuromorphic compute block.

FIGS. 3B-3C are simplified block diagrams illustrating neuromorphic cores in an example neuromorphic compute block.

FIGS. 4A-4B are simplified block diagram illustrating portions of example spiking neural networks (SNNs).

FIGS. 5A-5D are simplified block diagrams illustrating propagation of spike messages within a network of neuromorphic cores implementing a SNN.

FIG. 6 is a simplified flow diagram illustrating an example microarchitecture of an example neuromorphic core.

FIG. 7 is a simplified block diagram illustrating an example implementation of a neuromorphic acoustic processing block.

FIGS. 8A-8B are simplified block diagrams illustrating the comparative performance of an example acoustic recognition task.

FIG. 9 is a simplified block diagram illustrating performance of an example acoustic recognition task.

FIG. 10 is a flow diagram showing an example technique for performing acoustic recognition tasks end-to-end using a neuromorphic processing block of a computing device.

FIG. 11 is a simplified block diagram of an example processor of a computing device.

FIG. 12 is a simplified block diagram of an example computing system.

Like reference numbers and designations in the various drawings indicate like elements.

### DETAILED DESCRIPTION OF EXAMPLE EMBODIMENTS

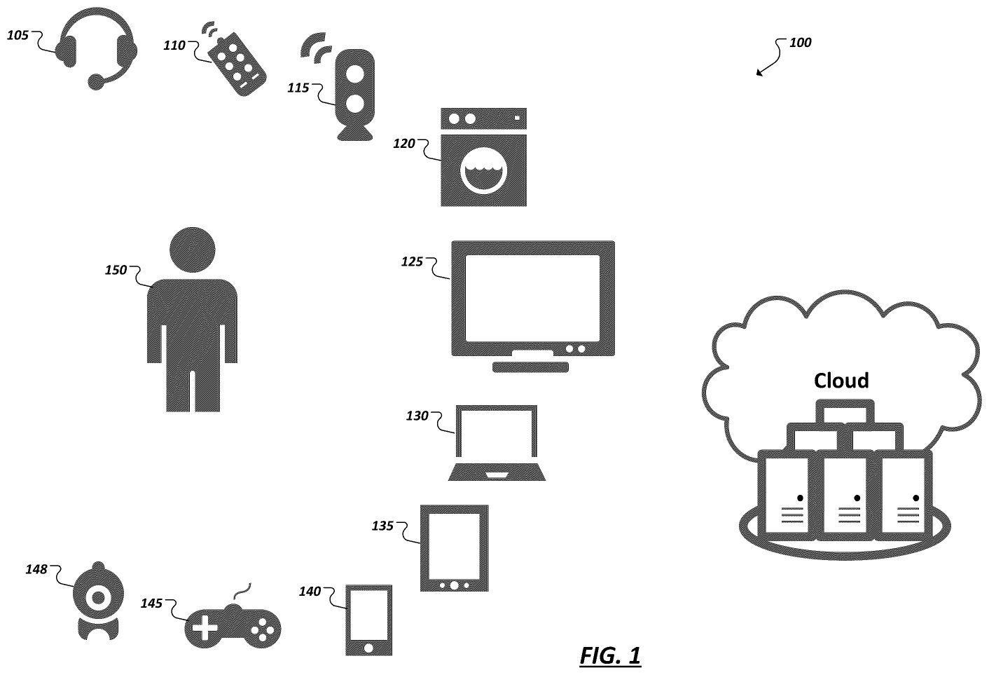

Microphones have become one of the most important components of modern computing devices and are increasingly used to implement an alternate or primary user interface with such devices. FIG. 1 is a simplified block diagram 100 illustrating an environment, in which various devices 105, 110, 115, 120, 125, 130, 135, 140, 145, etc. are provided within an environment and include microphones and logic to implement audio and acoustic algorithms supporting functionality and applications of the devices. Some devices may utilize their microphone to perform autonomous, or “intelligent” listening to detect sounds corresponding to user inputs or events, which may further trigger additional functionality of the device. As examples, a device, such as a headphone/speaker device 105, remote control with voice control capabilities 110, or personal assistant device 115, among other examples, may include wake on voice capabilities, such that the microphone may continuously listen for a human voice prompt, even while in a sleep or low power state, to which the device will response, for instance, by reactivating controls or logic in response to detecting a human voice or specific vocal command, among other examples. Similarly, devices may include functionality to recognize and respond to defined keywords (or keyword spotting) received at the device's microphone, such as that of a personal assistant device 115, smart appliances 120, smart televisions 125, personal computers (e.g., laptop devices 130, tablet computers 135, smartphones 140, etc.), video gaming system 145 (e.g., a set-top system, virtual reality headset, handheld gaming system, etc.), among other examples. For instance, a particular defined keyword (or multiple different keywords) may be defined to trigger additional functionality or action by the device. As an example, a human user 150 may begin more sophisticated verbal commands using an initial keyword (e.g., “hey Siri”, “Alexa . . . ”, “hey Google . . . ”, etc.) to indicate to the device that an immediately following command or question is to be processed by the device (e.g., using more advanced speech recognition functionality provided at the device locally or through communication and cooperation with a remote system 155 (e.g., a cloud service) over a communication network 160. Devices may also be equipped with logic to detect, through sounds captured at its microphone, events or contexts (e.g., acoustic context detection), which may trigger additional hardware, logic, functionality, or actions by the device. As one example, a network-attached audio sensor 148 (e.g., a security camera equipped with audio, a baby monitor, etc.) or other device may be equipped with logic to identify the occurrence of particular events or conditions (e.g., a baby waking/crying, an animal's behavior, general conditions in a surrounding environment, etc.) based on sounds captured at the device's microphone. Based on this context or event, various settings or actions may be autonomously deployed at the device (e.g., recording audio that follows, triggering an alert, adjusting sound settings (e.g., to employ noise reduction features, automatically increase or decrease volume, etc.)), among a variety of other examples. Indeed, it should be appreciated that the range of devices illustrated and named in the example above may be, in practice, much wider and diverse than illustrated herein (due to the sake of brevity), and functionality discussed herein may be supported by any one of these various devices and enhanced using the solutions discussed herein.

In conventional acoustic signal processing, the pipeline includes signal preprocessing, forward and inverse fast Fourier transforms (FFT), acoustic frontend logic, and deep neural network scoring. In some implementations, lower power applications may be achieved through targeted hardware acceleration, such as through a digital signal processor (DSP), deep neural network accelerator, among other examples. Algorithms for converting audio signals into features usable within various neural networks, including SNNs, may include calculating Mel-Frequency Cepstral Coefficients (MFCC) and then transforming these into spike trains usable by the SNN. In some examples, MFCC and Gammatone Cepstral Coefficients (GTCC) may be used in a Self-Organizing Map (MAP) algorithm to be converted into spikes for detection of acoustic events and scenes (e.g., robust sound classification). In another example, feature representation may be theoretically simplified using local time-frequency information (LTF). In some cases, MFCC features, which are usually calculated from the entire microphone signal spectrum, are vulnerable to noise and the applicability of spectrogram features makes its applicability restricted. However, in conventional methodologies, acoustic recognition tasks carried out on neuromorphic hardware have been dependent on a DSP to assist the neuromorphic hardware in generating an output. For instance, in an example key word spotting (KWS) workload, the SNN implemented on the neuromorphic hardware is fed with MFCC-based features determined using a DSP or other external processing hardware. In other examples, microphone signals may be transformed into a feature set input for the neuromorphic hardware's SNN using Short Time Fourier Transform (STFT) spectrograms determined using a DSP, among other examples. Indeed, as such this solution provides good acoustic information in time and frequency domain.

Traditional digital signal processing (DSP) techniques, while effective, may tax the computing resources of a platform and lead to inefficient power usage. For instance, frequent or always on acoustic processing using a DSP or related conventional hardware may result in poor power performance, which may be burdensome to portable or battery-powered devices. For instance, conventional DSP techniques may commonly apply multiply-accumulate (MAC) operations over a collection of discrete samples codified as fixed- or floating-point representation. MAC operations often require dedicated and complex resources, such as float-point multipliers, which may be implemented in specialized hardware or in FPGAs as dedicated (and expensive) resources in relatively small quantities. Applying a sequence of MAC operations over a data set with these units involves multiplexing them in time and reusing the multiplier with different input data and output results, which are stored in a global memory. Further, traditional DSP technique often relies upon high-frequency clock signals to achieve a competitive data throughput and large memory depths to store intermediate data and results are needed. In aggregate, these aspects of DSP acoustic processing result in large power consumption profiles and circuitry complexity, among other example issues.

Neuromorphic computing is an emerging alternative to algorithms based on deep neural networks (DNN). Neuromorphic computing aims to solve cognitive tasks using a computer with brain-like energy efficiency. In some implementations, when applied to audio tasks, neuromorphic computing may provide an advantage over DNN algorithms used to perform similar tasks, both in terms of power, latency, and memory (e.g., RAM) requirements. Hardware accelerators may be utilized to implement spiking neural networks (SNN) completely in hardware. Generally, a neural network implemented using neuromorphic computing may be more power-efficient than a comparable DNN, the gains from a practical neuromorphic solution may be limited within audio and acoustic processing. For instance, conventional neuromorphic computing solutions (e.g., dedicated chips (e.g., Spinnaker™, TrueNorth™, Liohi™, etc.), IP blocks, or hardware accelerators) are still reliant on the platforms digital signal processing hardware (e.g., the platform DSP), as the DSP has to be engaged for reading samples into the neuromorphic network, computing input spikes for the neuromorphic network, feeding the spikes into the neuromorphic network, and interpreting spike outputs of the neuromorphic network, etc. Accordingly, conventional neuromorphic solutions lean so heavily on the DSP that the DSP is to remain an active participant throughout the neuromorphic hardware's processing so as to erase any potential efficiency and power savings gains.

Modern acoustic recognition tasks and functionality are often implemented utilizing neural networks, such as deep neural networks. In some cases, specialized accelerators may be provided in a computing system that are designed to perform computations and optimize data movement for certain types of artificial neural networks (ANNs). For instance, a streaming ANN accelerator may execute an ANN (e.g., a DNN), loading the model from memory in association with each inference performed (e.g., for each frame of audio). Neuromorphic computing, however, follows a processing-in-memory-paradigm and can reduce the power overhead relative to ANN accelerators. Moreover, spiking neural networks is designed as an asynchronous approach. In an ANN accelerator, the power may be gated by clock, whereas in the neuromorphic domain it is gated by the spikes themselves. This enables additional savings (e.g., post-synaptic spikes will not fire when pre-synaptic spikes do not exceed the spike threshold and, as a result, all the neurons receiving the post-synaptic spikes will remain inactive and therefore save power). It is also possible to train an SNN so as to enforce triggering behavior of the model (e.g., keep the large parts of the model inactive unless a s spike is emitted in lower layers), among other example advantages.

In an improved system, a neuromorphic acoustic processing subsystem may be equipped with circuitry to implement acoustic processing tasks end-to-end, entirely within the neuromorphic computing device's hardware, without direct involvement of a DSP or host processor with the SNN's operation, such as discussed above. Instead, an improved neuromorphic computing device may bind its processing modules implemented in the neuromorphic architecture to cover a variety of audio related tasks such as wake on voice (WoV), acoustic event and acoustic context detection (AED, ASC), instant speech detection (ISD), dynamic noise suppression (DNS), among other examples. A system interfacing with the neuromorphic acoustic processing device may implement a pipeline to feed data generated by microphones of the system in an autonomous manner so as to further realize the power savings and latency benefits achievable through neuromorphic computing, among other example benefits. Indeed, using an end-to-end neuromorphic architecture for certain audio processing tasks, significant energy savings can be achieved, which surpass the efficiency of both existing deep neural network solutions, as well as conventional neuromorphic audio solutions and the pipeline executed in the existing audio subsystem.

In one example, an improved system may be provided with a neuromorphic subsystem incorporating a firmware and hardware topology that enables acoustic processing within neuromorphic hardware with minimal involvement of DSP processing overhead to yield significant power advantages over conventional solutions utilizing ANN solutions or neuromorphic solutions enabled through DSP parallel processing. For instance, the improved neuromorphic subsystem may be implemented as neuromorphic chip, accelerator, or IP block with a fixed function block to convert audio samples into spike events at the neuromorphic subsystem (e.g., without the assistance of a DSP, use of FFTs, or MFCCs, etc.) and a neuromorphic processor with neuromorphic cores programmable to implement a SNN to perform inferences on spike trains generated by the fixed function block. The neuromorphic subsystem hardware may further implement a process flow configured to autonomously feed digital audio signal data from the microphone of a computing device, from which the neuromorphic subsystem may produce spike trains and feed the spike trains to an SNN implemented on the neuromorphic subsystem trained to recognize particular sounds in accordance with the performance of various acoustic tasks (such as discussed herein).

A variety of different computing devices (e.g., 105-148) may be improved through the inclusion of an improved neuromorphic acoustic processing subsystem, such as discussed herein. For instance, devices may have increased power and latency profiles. For instance, the use or a neuromorphic acoustic processing subsystem in lieu of a more conventional DNN-based solution may realize an order of magnitude improvement in inference power and a substantial (e.g., 3×) improvement of total platform power in Wake on Voice use cases. In some implementations, neuromorphic models are projected to be considerably smaller than existing DNN models, which translates to less energy and die size. Another attractive feature of SNN is adaptability to changing conditions, which provides accuracy improvement over time. Further, by consolidating the logic implementing certain acoustic recognition tasks within an improved neuromorphic acoustic processing subsystem, the processing pipeline may make use of less DSP code than in existing solutions, making maintenance of this pipeline less expensive from a developmental standpoint. By reducing power usage, latency, and complexity, the inclusion of neuromorphic acoustic processing within a device may enable corresponding acoustic recognition functionality to be integrated within devices (e.g., portable, battery powered devices, etc.), where conventional acoustic processing was too burdensome. Further, neuromorphic computing theory posits that neuromorphic models may realize improved adaptability to external conditions, which may additionally translate to more accurate inferences and results in acoustic processing, which may yield improved user experience with such devices, among other example advantages.

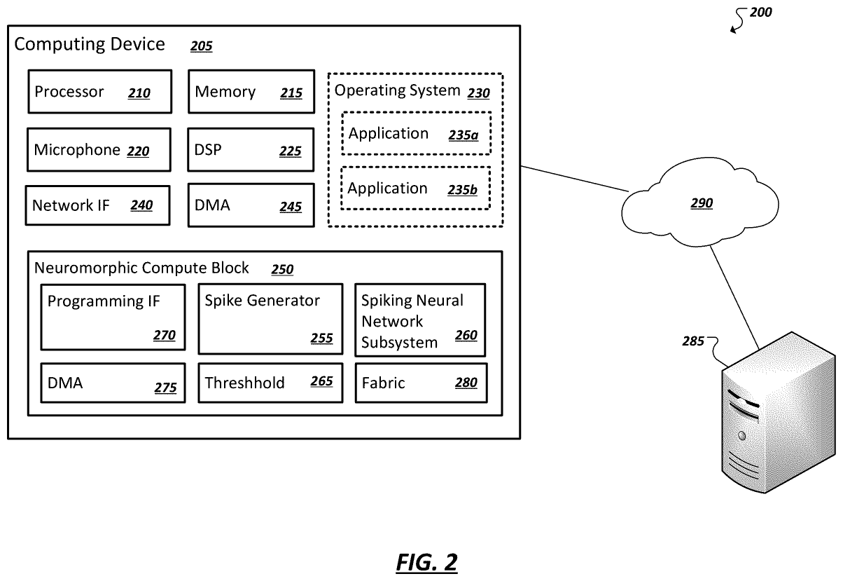

FIG. 2 is a simplified block diagram 200 illustrating an example computing system including an example computing device 205, such as a personal computer (e.g., laptop, smartphone, gaming system, etc.), recording device (e.g., headset, microphone device, security monitor, etc.), in-vehicle system, smart appliance (e.g., voice activated or controlled thermostat, television, or other appliance), digital assistant, among other examples. In one example, computing device 205 may include a CPU, host processor, or other processor device 210 to execute an operating system 230 and one or more applications (e.g., 235a-b) to be run on the operating system 230. The computing device 205 may include one or more blocks of memory 215 in which data and programs may be stored. The computing device 205 may include one or more multiple microphones 220, which may be digital microphones or analog microphones with analog-to-digital converter circuitry to generate digital microphone signal data for use by various logical elements of the device 205. For instance, some acoustic processing functionality for the device 205 may be “on” even when the computing device 205 is in a low-power state, such as wake-on-voice, keyword spotting, and other examples, to trigger additional functionality of the computing device (e.g., an automatic wake event, triggering the activation of other circuitry or logic and associated workloads, etc.). In some cases, a digital signal processor (DSP) 225 may be included and utilized on the computing device 205 to perform a subset of acoustic processing activities and implement associated functionality for the device 205 (e.g., higher-level speech or voice recognition, preparing data for various applications 235a-b consumption, etc.). In some implementations, the computing device 205 may include network interface logic 240 to couple the computing device to one or more other systems (e.g., 285) via one or more networks (e.g., 290). In some cases, the computing device 205 (e.g., with the assistance of the DSP 225) may prepare data to be processed by cloud-based acoustic processing systems or other distributed systems.

A variety of functionality may be enabled through the provision of a microphone 220 and the use of digital audio data generated through the microphone 220. For instance, the computing device may monitor and capture various events (e.g., security events, baby or animal monitoring, safety events (e.g., within a car or affecting the person using a device), support a voice user interface for the device 205, support speech-to-text engines, among other examples. Applications (e.g., 235a-b) may make direct or incidental use of the acoustic recognition results generated using the computing device's microphone data. As one example, an application (e.g., 235a) may implement a search engine, with the microphone (and supporting acoustic processing functionality) enabling a voice user interface for the search engine. As another example, an application (e.g., 235b) may implement a monitoring application, which depends on the microphone 220 and as its data as core inputs, among other examples.

An example computing device 205 may additionally be equipped with a neuromorphic acoustic subsystem 250 to implement a neuromorphic acoustic processing subsystem to handle at least a portion of the acoustic processing functionality of the computing device 205. In one example, a direct memory access (DMA) engine 245 may be provided (and programmed) to write audio data generated by the microphone 220 to at least a portion of the memory 215 (e.g., SRAM memory), even when main elements of the computing device (e.g., processor 210, DSP 225, network interface 240, etc.) are in a low power mode. The microphone data may be accessible by the neuromorphic acoustic subsystem 250 utilizing its own DMA engine 275 to process the microphone data using an SNN implemented using a SNN subsystem 260 (e.g., a network of neuromorphic cores) of the neuromorphic acoustic subsystem 250 to perform one or more acoustic tasks.

An example neuromorphic acoustic subsystem 250 may include hardware and/or firmware logic to support end-to-end performance of one or more acoustic recognition tasks without the intervention of DSP 225, processor 210, another compute element outside of the neuromorphic acoustic subsystem 250. In one example, the neuromorphic acoustic subsystem 250 may include a spike generator to convert audio sample data (e.g., frames of an audio signal generated by the microphone 220) into one or more spike trains. The spike trains may be input to the SNN implemented by 260 and trained to support one or more acoustic recognition tasks. The output of the SNN (generated using the SNN subsystem 260) may be provided, in some cases, to threshold detection logic 265 (e.g., implemented in hardware circuitry), which may generate a value (e.g., a binary value corresponding to an output spike), which may be written back to memory 215 (e.g., in a register) to trigger an interrupt or other action to cause additional functionality to be performed using other hardware of the computing device 205 outside of the neuromorphic acoustic subsystem 250. In some cases, threshold logic 265 may be integrated within the SNN (e.g., as an output layer). In other cases, the threshold logic 265 may convert spikes generated by the SNN output layer (e.g., particular combinations of output spikes) into result data fit for communication to and consumption by other elements of the computing device 205, among other examples.

In some implementations, the neuromorphic acoustic subsystem 250 may further a programming interface 270 through which an SNN implemented using SNN subsystem 260 may be defined or configured, a spike generator 255 may be tuned or configured, use of the DMA engine 275 can be defined to orchestrate autonomous delivery of audio data from the microphone 220 to the neuromorphic acoustic subsystem 250 (e.g., even when other elements of the computing device 205 are inactive), among other example uses. An interconnect fabric 280 may also be provided within the neuromorphic acoustic subsystem 250 to facilitate the passing of data between the various components (e.g., 255, 260, 265, 270, 275, etc.) of the neuromorphic acoustic subsystem 250, among other example components.

In general, “servers,” “clients,” “computing devices,” “network elements,” “hosts,” “system-type system entities,” “user devices,” “gateways,” “IoT devices,” “sensor devices,” and “systems” (e.g., 205, 285, etc.) in an example computing environment, can include electronic computing devices operable to receive, transmit, process, store, or manage data and information associated with the computing environment. As used in this document, the term “computer,” “processor,” “processor device,” or “processing device” is intended to encompass any suitable processing apparatus. For example, elements shown as single devices within the computing environment may be implemented using a plurality of computing devices and processors, such as server pools including multiple server computers. Further, any, all, or some of the computing devices may be adapted to execute any operating system, including Linux, UNIX, Microsoft Windows, Apple OS, Apple IOS, Google Android, Windows Server, etc., as well as virtual machines adapted to virtualize execution of a particular operating system, including customized and proprietary operating systems.

In some implementations, a computing device 205 may be participate with other devices, such as wearable devices, Internet-of-Things devices, connected home devices (e.g., home health devices), and other devices in a machine-to-machine network, such as Internet-of-things (IoT) networking, a fog network, connect home network, or other network (e.g., using wireless local area networks (WLAN), such as those standardized under IEEE 802.11 family of standards, home-area networks such as those standardized under the Zigbee Alliance, personal-area networks such as those standardized by the Bluetooth Special Interest Group, cellular data networks, such as those standardized by the Third-Generation Partnership Project (3GPP), and other types of networks, having wireless, or wired, connectivity).

Neuromorphic computing may involve the use of very-large-scale integration (VLSI) systems containing electronic circuits to mimic neuro-biological architectures present in the nervous system to imbue computing systems with “intelligence”. A desirable feature of neuromorphic computing is its ability to autonomously extract high dimensional spatiotemporal features from raw data streams that can reveal the underlying physics of the system being studied thus making them amenable for rapid recognition. Such features may be useful in big data and other large-scale computing problems. Neuromorphic computing platforms may be provided which adopts an energy efficient architecture inspired by the brain that is both scalable and energy efficient while also supporting multiple modes of learning on-chip. Furthermore, such neuromorphic computing hardware may be connected to, integrated with, or otherwise used together with general computing hardware (e.g., a CPU) to support a wide range of traditional workloads as well as non-traditional workloads such as dynamic pattern learning and adaptation, constraint satisfaction and sparse coding using a single compute platform. Such a solution may leverage understandings from biological neuroscience regarding the improvement of system level performance by leveraging various learning modes such as unsupervised, supervised and reinforcement using spike timing and asynchronous computation, among other example features and considerations.

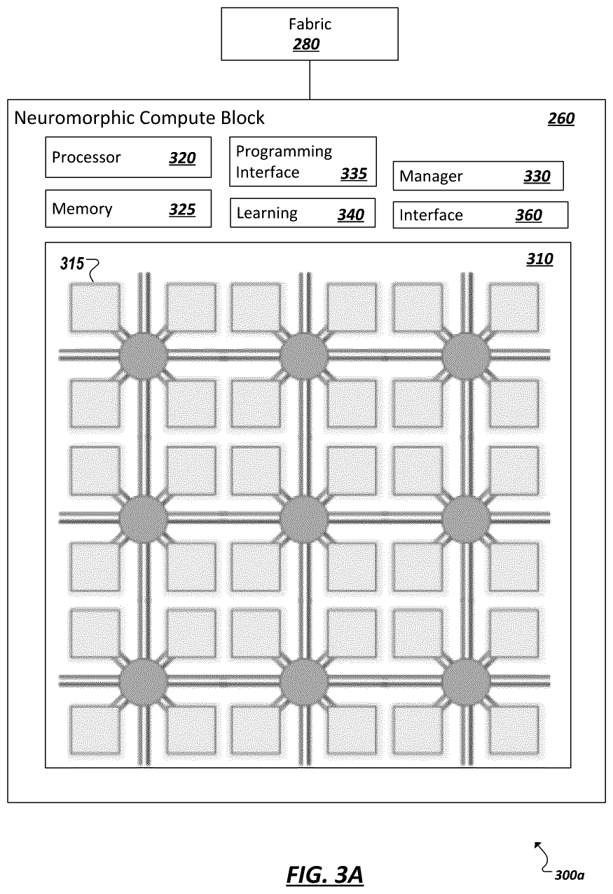

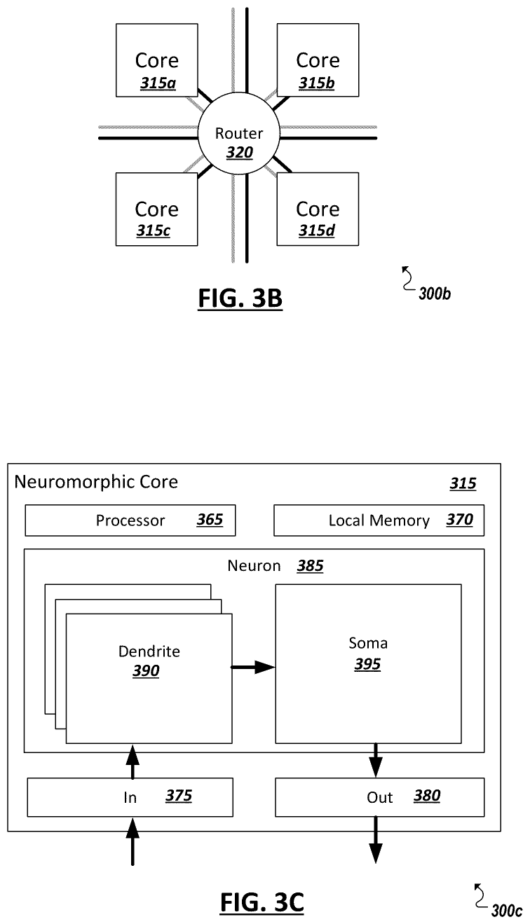

In one implementation, a neuromorphic computing system is provided that adopts a multicore architecture (e.g., within an SNN subsystem 260, etc.) where each neuromorphic core houses the computing elements including hardware-implemented neurons, synapses with on-chip learning capability, and local memory to store synaptic weights and routing tables. FIG. 3A is a simplified block diagram 300 illustrating an example of at least a portion of such a neuromorphic computing block (e.g., to implement a SNN subsystem 260). As shown in this example, a neuromorphic compute block 260 may be provided with a network 310 of multiple neural network cores (e.g., 315) interconnected by an on-device network such that multiple different connections may be potentially defined between the cores. For instance, a network 310 of spiking neural network cores may be provided in the neuromorphic compute block 260 and may each communicate via short, packetized spike messages sent from core to core over the network channels. Each core (e.g., 315) may possess processing and memory resources and logic to implement some number of primitive nonlinear temporal computing elements, such as multiple (e.g., 1000+) distinct artificial neurons (referred to herein as “neurons”). Learning logic 340 may be provided (e.g., globally or for each neuromorphic core) to implement feedback and dynamic training of the SNN to adjust attributes of individual neurons to allow the neurons to “learn” from previous spike trains and patterns (e.g., using spike time dependent plasticity (STDP) or another learning scheme). In some implementations, each core may be capable of concurrently implementing multiple neurons such that the collection of neuromorphic cores may implement many multiples of neurons using the device.

Continuing with the example of FIG. 3A, a neuromorphic compute block 260 may additionally include a co-processor 320 and memory 325 to implement one or more components to manage and provide functionality of the device. For instance, a system manager 330 may be provided to manage global attributes and operations of the device (e.g., attributes affecting the network of cores 310, multiple cores in the network, interconnections of the neuromorphic compute block 260 with other devices, manage access to global system memory 325, among other potential examples). In one example, a system manager 330 may manage the definition and provisioning of a specific routing tables to the various routers in the network 310, orchestration of a network definition and attributes (e.g., weights, decay rates, etc.) to be applied in the network, core synchronization and time multiplexing management, routing of inputs to the appropriate cores, among other potential functions.

As another example, a neuromorphic computing block 260 may additionally include a programming interface 335 (which may operate in connection with a neuromorphic processing subsystem's programming interface 270) through which a user or system may specify a neural network definition to be applied (e.g., through a routing table and individual neuron properties) and implemented by the mesh 310 of neuromorphic cores. A software-based programming tool may be provided with or separate from the neuromorphic compute block 260 through which a user may provide a definition for a particular neural network to be implemented using the network 310 of neuromorphic cores. The programming interface 335 may take the input of the programmer to then generate corresponding routing tables and populate local memory of individual neuromorphic cores (e.g., 315) with the specified parameters to implement a corresponding, customized network of artificial neurons implemented by the neuromorphic cores.

The neuromorphic compute block 260 may advantageously interface with and interoperate with other devices, such as the other components of an example neuromorphic acoustic processing subsystem, to realize certain applications and use cases. Accordingly, external interface logic 360 may be provided in some cases to communicate (e.g., over one or more defined communication protocols) with one or more other devices. An external interface 360 may be utilized to accept input data from another device or external memory controller acting as the source of the input data. An external interface 360 may be additionally or alternatively utilized to allow results or output of computations of a neural network implemented using the neuromorphic compute block 260 to be provided to another device (e.g., another general purpose processor implementing a machine learning algorithm) to realize additional applications and enhancements, among other examples.

As shown in FIG. 3B, a block diagram 300b is shown illustrating a portion of a network fabric interconnecting multiple neuromorphic cores (e.g., 315a-d). For instance, a number of neuromorphic cores (e.g., 315a-d) may be provided in a mesh, with each core being interconnected by a network including a number of routers (e.g., 350). In one implementation, each neuromorphic core (e.g., 315a-d) may be connected to a single one of the routers (e.g., 350) and each of the routers may be connected to at least one other router (as shown at 310 in FIG. 3A). As an example, in one particular implementation, four neuromorphic cores (e.g., 315a-d) may be connected to a single router (e.g., 350) and each of the routers may be connected to two or more other routers to form a manycore mesh, allowing each of the neuromorphic cores to interconnect with each other neuromorphic core in the device. Moreover, as each neuromorphic core may be configured to implement multiple distinct neurons, the router network of the device may similarly enable connections, or artificial synapses (or, simply, “synapses”), to be defined between any two of the potentially many (e.g., 30,000+) neurons defined using the network of neuromorphic cores provided in a neuromorphic computing device.

FIG. 3C shows a block diagram 300c illustrating internal components of one example implementation of a neuromorphic core 315. In one example, a single neuromorphic core may implement some number of neurons (e.g., 1024 neurons) that share architectural resources of the neuromorphic core in a time-multiplexed manner. In one example, each neuromorphic core 315 may include a processor block 365 capable of performing arithmetic functions and routing in connection with the realization of a digitally implemented artificial neuron, such as explained herein. Each neuromorphic core 315 may additionally provide local memory (e.g., 370) in which a routing table may be stored and accessed for a neural network, accumulated potential of each soma of each neuron implemented using the core may be tracked, parameters of each neuron implemented by the core may be recorded, among other data and usage. Components, or architectural resources, of a neuromorphic core 315 may further include an input interface 375 to accept input spike messages generated by other neurons on other neuromorphic cores and an output interface 380 to send spike messages to other neuromorphic cores over the mesh network. In some instances, routing logic for the neuromorphic core 315 may be at least partially implemented using the output interface 380. Further, in some cases, a core (e.g., 315) may implement multiple neurons within an example SNN and some of these neurons may be interconnected. In such instances, spike messages sent between the neurons hosted on the particular core may forego communication over the routing fabric of the neuromorphic computing device and may instead by managed locally at the particular neuromorphic core.

Each neuromorphic core may additionally include logic to implement, for each neuron 385, an artificial dendrite 390 and an artificial soma 395 (referred to herein, simply, as “dendrite” and “soma” respectively). The dendrite 390 may be a hardware-implemented process that receives spikes from the network. The soma 395 may be a hardware-implemented process that receives each dendrite's accumulated neurotransmitter amounts for the current time and evolves each dendrite and soma's potential state to generate outgoing spike messages at the appropriate times. A dendrite 390 may be defined for each connection receiving inputs from another source (e.g., another neuron). In one implementation, the dendrite process 390 may receive and handle spike messages as they serially arrive in time-multiplexed fashion from the network. As spikes are received, the neuron's activation (tracked using the soma 395 (and local memory 370)) may increase. When the neuron's activation exceeds a threshold set for the neuron 385, the neuron may generate a spike message that is propagated to a fixed set of fanout neurons via the output interface 380. The network distributes the spike messages to all destination neurons, and in response to those neurons, in turn, update their activations in a transient, time-dependent manner, and so on, potentially causing the activation of some of these destination neurons to also surpass corresponding thresholds and trigger further spike messages, as in real biological neural networks.

As noted above, a neuromorphic computing device may reliably implement a spike-based model of neural computation, or a spiking neural network (SNN). In addition to neuronal and synaptic state, SNNs also incorporate the concept of time. For instance, in an SNN, communication occurs over event-driven action potentials, or spikes, that convey no explicit information other than the spike time as well as an implicit source and destination neuron pair corresponding to the transmission of the spike. Computation occurs in each neuron as a result of the dynamic, nonlinear integration of weighted spike input. In some implementations, recurrence and dynamic feedback may be incorporated within an SNN computational model. Further, a variety of network connectivity models may be adopted to model various real world networks or relationships, including fully connected (all-to-all) networks, feed-forward trees, fully random projections, “small world” networks, among other examples. A homogeneous, two-dimensional network of neuromorphic cores, such as shown in the example of FIGS. 3A-3C may advantageously support all of these network models. As all cores of the device are connected, all neurons defined in the cores are therefore also fully connected through some number of router hops. The device may further include fully configurable routing tables to define a variety of different neural networks by allowing each core's neurons to distribute their spikes to any number of cores in the mesh to realize fully arbitrary connectivity graphs.

In an improved implementation of a system capable of supporting SNNs, high speed and reliable circuits may be provided to implement SNNs to model the information processing algorithms as employed by the brain, but in a more programmable manner. For instance, while a biological brain can only implement a specific set of defined behaviors, as conditioned by years of development, a neuromorphic processor device may provide the capability to rapidly reprogram all neural parameters. Accordingly, a single neuromorphic processor may be utilized to realize a broader range of behaviors than those provided by a single slice of biological brain tissue. This distinction may be realized by adopting a neuromorphic processor with neuromorphic design realizations that differ markedly from those of the neural circuits found in nature.

As an example, a neuromorphic processor may utilize time-multiplexed computation in both the spike communication network and the neuron machinery of the device to implement SNNs. Accordingly, the same physical circuitry of the processor device may be shared among many neurons to realize higher neuron density. With time multiplexing, the network can connect N cores with O(N) total wiring length, whereas discrete point-to-point wiring would scale as O(N²), realizing a significant reduction in wiring resources to accommodate planar and non-plastic VLSI wiring technologies, among other examples. In the neuromorphic cores, time multiplexing may be implemented through dense memory allocation, for instance, using Static Random Access Memory (SRAM), with shared buses, address decoding logic, and other multiplexed logic elements. State of each neuron may be stored in the processor's memory, with data describing each neuron state including state of each neuron's collective synapses, all currents and voltages over its membrane, among other example information (such as configuration and other information).

In one example implementation, a neuromorphic processor may adopt a “digital” implementation that diverts from other processors adopting more “analog” or “isomorphic” neuromorphic approaches. For instance, a digital implementation may implement the integration of synaptic current using digital adder and multiplier circuits, as opposed to the analog isomorphic neuromorphic approaches that accumulate charge on capacitors in an electrically analogous manner to how neurons accumulate synaptic charge on their lipid membranes. The accumulated synaptic charge may be stored, for instance, for each neuron in local memory of the corresponding core. Further, at the architectural level of an example digital neuromorphic processor, reliable and deterministic operation may be realized by synchronizing time across the network of cores such that any two executions of the design, given the same initial conditions and configuration, will produce identical results. Asynchrony may be preserved at the circuit level to allow individual cores to operate as fast and freely as possible, while maintaining determinism at the system level. Accordingly, the notion of time as a temporal variable may be abstracted away in the neural computations, separating it from the “wall clock” time that the hardware utilized to perform the computation. Accordingly, in some implementations, a time synchronization mechanism may be provided that globally synchronizes the neuromorphic cores at discrete time intervals. The synchronization mechanism allows the system to complete a neural computation as fast as the circuitry allows, with a divergence between run time and the biological time that the neuromorphic system models.

In operation, the neuromorphic mesh device may begin in an idle state with all neuromorphic cores inactive. As each core asynchronously cycles through its neurons, it generates spike messages that the mesh interconnect routes to the appropriate destination cores containing all destination neurons. As the implementation of multiple neurons on a single neuromorphic core may be time-multiplexed, a time step may be defined in which all spikes involving the multiple neurons may be processed and considered using the shared resources of a corresponding core. As each core finishes servicing its neurons for a respective time step, the cores may, in some implementations, communicate (e.g., using a handshake) with neighboring cores using synchronization messages to flush the mesh of all spike messages in flight, allowing the cores to safely determine that all spikes have been serviced for the time step. At that point all cores may be considered synchronized, allowing them to advance their time step and return to the initial state and begin the next time step.

Given this context, and as introduced above, a device (e.g., 305) implementing a mesh 310 of interconnected neuromorphic cores may be provided, with the core implementing potentially multiple artificial neurons capable of being interconnected to implement an SNN. Each neuromorphic core (e.g., 315) may provide two loosely coupled asynchronous processes: an input dendrite process (e.g., 380) that receives spikes from the network and applies them to the appropriate destination dendrite compartments at the appropriate future times, and an output soma process (e.g., 385) that receives each dendrite compartment's accumulated neurotransmitter amounts for the current time and evolves each dendrite and soma's membrane potential state, generating outgoing spike messages at the appropriate times (e.g., when a threshold potential of the soma has been reached). Note that, from a biological perspective, the dendrite and soma names used here only approximate the role of these functions and should not be interpreted too literally.

Spike messages may identify a particular distribution set of dendrites within the core. Each element of the distribution set may represent a synapse of the modeled neuron, defined by a dendrite number, a connection strength (e.g., weight W), a delay offset D, and a synapse type, among potentially other attributes. In some instances, each weight Wᵢ may be added to the destination dendrite's total current u scheduled for servicing at time step T+Dᵢ in the future. While not handling input spikes, the dendrite process may serially service all dendrites sequentially, passing the total current u for time T to the soma stage. The soma process, at each time step, receives an accumulation of the total current u received via synapses mapped to specific dendritic compartments of the soma. In the simplest case, each dendritic compartment maps to a single neuron soma. In other instances, a neuromorphic core mesh architecture may additionally support multi-compartment neuron models. Core memory may store the configured attributes of the soma and the state of the soma, the total accumulated potential at the soma, etc. In some instances, synaptic input responses may be modeled in the core with single-timestep current impulses, low state variable resolution with linear decay, and zero-time axon delays, among other example features. In some instances, neuron models of the core may be more complex and implement higher resolution state variables with exponential decay, multiple resting potentials per ion channel type, additional neuron state variables for richer spiking dynamics, dynamic thresholds implementing homeostasis effects, and multiple output spike timer state for accurate burst modeling and large axonal delays, among other example features. In one example, the soma process implemented by each of the neuromorphic cores may implement a simple current-based Leaky Integrate-and-Fire (LIF) neuron model or other example neuron models, among other examples.

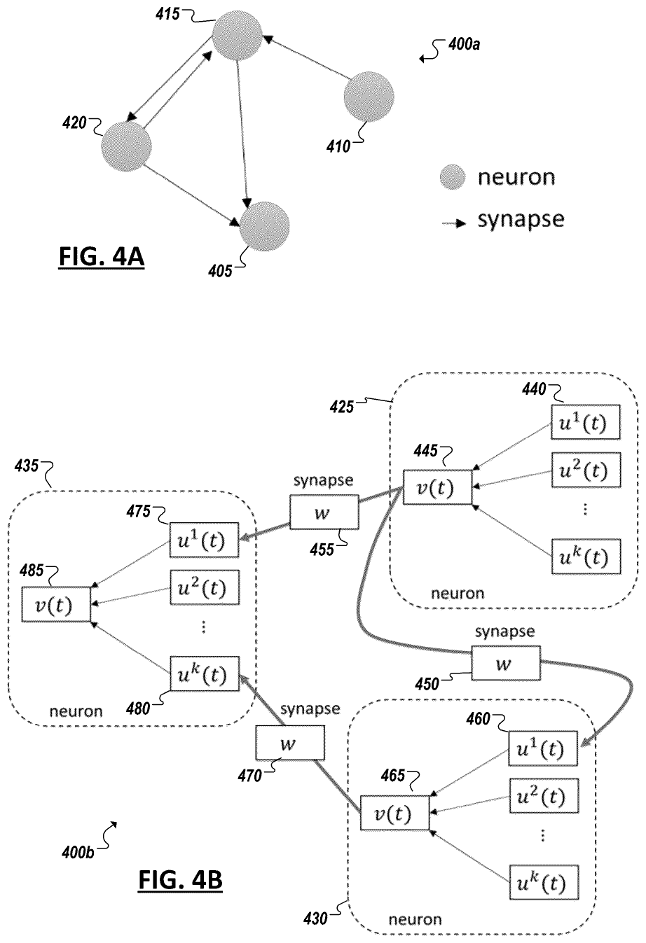

A neuromorphic computing device, such as introduced in the examples above, may be provided to define a spiking neural network architecture abstraction that can efficiently solve a class of sparse coding problems. As noted above, the basic computation units in the architecture may be neurons and the neurons may be connected by synapses, which define the topology of the neural network. Synapses are directional, and neurons are able to communicate to each other if a synapse exists. FIG. 4A is a simplified block diagram 400a illustrating a simple example neural network, including neurons 405, 410, 415, 420 connected by synapses. The synapses allow spike messages to be transmitted between the neurons. For instance, neuron 405 may receive spike messages generated by neurons 415, 420. As neuron 405 receives spike messages from the other neurons it is connected to, the potential of the neuron 405 may exceed a threshold defined for the neuron 405 (e.g., defined in its soma process) to cause the neuron 405 itself to generate and transmit a spike message. As noted, synapses may be directional. In some cases, a network and corresponding synapses may be defined such that a neuron (e.g., 415) only receives or transmits to some of the other neuron (e.g., 405), while in synapses may be defined which connect the neuron bi-directionally with other neurons (e.g., between neurons 415, 420) to create a feedback loop, among other examples.

An example neuromorphic computing device may adopt leaky integrate-and-fire neurons and current-based synapses. Accordingly, the dynamics of the network may be driven by the evolution of the state variables in each neuron. In one example, each neuron has two types of state variables: one membrane potential v(t), and one or more dendritic current(s) u¹(t), . . . to u^{s}(t). Each dendritic current variable may be defined to decay exponentially over time, according to its respective decay time constant τₛ^{k}. The dendritic current may be linearly summed to control the integration of the membrane potential. Similar to dendritic current, the membrane potential may also be subject to exponential decay with a separate membrane potential time constant τₘ. When a neuron's membrane potential reaches a particular threshold voltage θ defined for the neuron, the neuron (e.g., through its soma process) resets the membrane potential to zero and sends out a spike to neighboring neurons connected by corresponding synapses. The dendrite process of each neuron can be defined such that a spike arrival causes a change in the dendritic current. Such interactions between neurons lead to the complex dynamics of the network. Spikes are transmitted along synapses and the incoming synapse may be defined to be associated with one dendritic current variable, e.g., using the dendritic compartment. In such implementations, each spike arrival changes only one dendritic current u^{k}(t). The change may be defined to manifest as an instantaneous jump in u^{k}(t). Accordingly, in some implementations, in addition to the state variables of a neuron, there are several other configurable parameters, including the time constant of individual dendritic compartment τₛ¹, . . . , τₛ^{s}, a single τₘ, θ, I^{bias} for each neuron, and a configurable weight value wᵢⱼ for each synapse from neuron j to i, which may be defined and configured to model particular networks.

For instance, FIG. 4B shows an example illustrating synaptic connections between individual dendrites of neurons in a network, and the parameters that may be defined for these neurons and synapses. As an example, in FIG. 4B, neurons 425, 430, 435 implemented by cores of an example neuromorphic computing device are shown, together with synapses defined (e.g., using a routing table) for interconnections within a neural network implemented using the neurons 425, 430, 435. Each neuron may include one or more dendrite (processes) (e.g., 440, 460, 475, 480) and a respective soma (process) (e.g., 445, 465, 485). Spike messages received at each of the dendrites of a respective neuron may contribute to the activation potential of the soma, with the soma firing a spike message when the soma-specific potential threshold is reached. A synapse connects two neurons. The synapse may effectively connect the soma of a sending neuron to one of the dendrites of the receiving neuron. Further, each synapse may be assigned a respective weight (e.g., 450, 455, 470). In the example of FIG. 4B, a synapse with a first weight 450 may connect soma 445 of neuron 425 with dendrite 460 of neuron 430. Soma 445 of neuron 425 may additionally connect to neuron 480 via another synapse (with potentially a different weight 455). Soma 465 of neuron 430 may also connect to neuron 480 via a respective synapse 470. In some cases, multiple neurons may connect to a particular neuron at the same dendrite of the particular neuron. In such instances, the parameters defined for this one dendrite will govern the effect of the incoming spike messages from each of the connected neurons. In other cases, such as shown in FIG. 4B, different neurons (e.g., 425, 430) may connect to the same neuron (e.g., 435) but at different dendrites (e.g., 475 and 480 respectively), allowing different parameters (defined for each of these dendrites (e.g., 475, 480)) to affect the respective spikes arriving from each of these different neurons (e.g., 425, 430). Likewise, parameters may be defined for each of the somas (e.g., 445, 465, 485) of each of the various neurons (e.g., 425, 430, 435) defined in the network, allowing these parameters to likewise contribute to the overall configurability of the neural network implemented using the neuromorphic computing device, among other examples.

As a summary, neuron parameters may include such examples as a synaptic decay time constant τₛ, bias current I_{b}, firing potential threshold θ, and synaptic weight wᵢⱼ from neuron to neuron (i.e., from neuron j to neuron i). These parameters may be set by a programmer of the neural network, for instance, to configure the network to model a real network, matrix, or other entity. Further, neuron state variables may be defined to include time-varying current u(t) and voltage v(t) and represented by corresponding ordinary differential equations.

In a digital neuromorphic computing device, a network of neuromorphic cores is provided (such as shown and discussed in connection with FIGS. 3A-3C), with each of the neuromorphic cores possessing processor resources and logic executable to solve the continuous network dynamics using first-order techniques, such as by approximating SNN dynamics using discrete time steps. In one example, a virtual global clock is provided in the neuromorphic computing device to coordinate the time-stepped updates of individual neurons at each core. Within a time step, every neuron implemented by the network of cores can adjust (e.g., in a time-multiplexed manner) its respective state variables and will do so no more than once per time step. Further, each spike message generated by a neuron in the SNN may be guaranteed to be delivered within a corresponding time step.

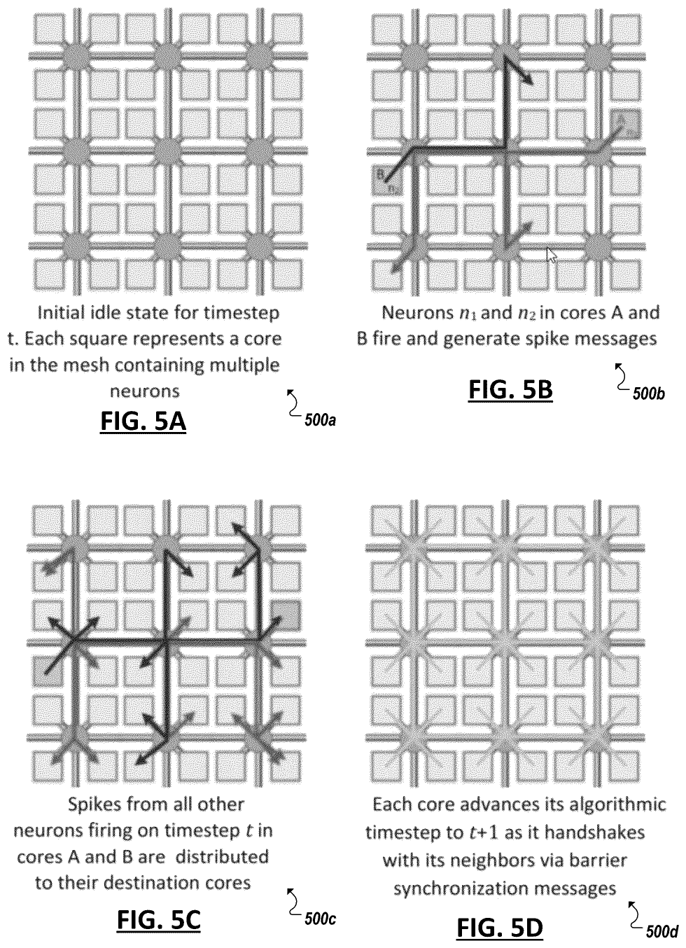

FIGS. 5A-5D are block diagrams 500a-d illustrating the example timestep-wise progression of spike events within a network of neuromorphic cores. FIG. 5A illustrates an initial idle state for a timestep t in a portion of a mesh network of neuromorphic cores, where each neuromorphic core possesses hardware to implement multiple neurons within an SNN. In FIG. 5B, spike messages fire from two different neurons on two different cores (e.g., 315a, 315b) are routed to other neuromorphic cores implementing the neurons connected to the firing neurons in the network. Multiple neurons implemented on a single core may fire in a single timestep (e.g., as shown in FIG. 5C). These spike messages may trigger other spike messages by the receiving neurons in subsequent timesteps (e.g., t+1). As illustrated in FIG. 5D, the cores may progress together to the next timestep, update attributes (e.g., its soma process potential) of each neuron (where applicable), and determine which (if any) other neurons are to fire spike additional spike messages in the next timestep based on these updated attribute values.

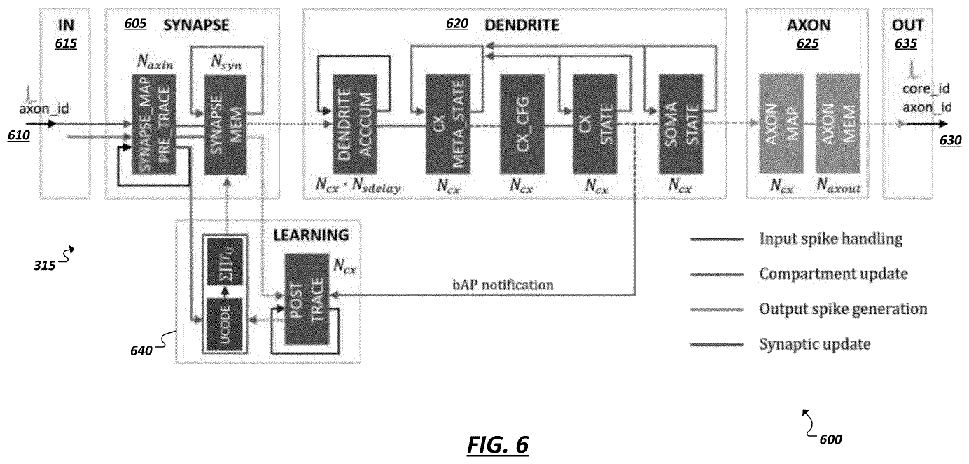

Turning to FIG. 6, a simplified block diagram 600 is shown illustrating the flow within an example neuromorphic core's 315 top-level microarchitecture. A synapse units 605 unit may receive spikes 610 from an input unit 615 and processes the incoming spikes and reads out the associated synaptic weights from memory. A dendrite unit 620 may update the state variables u and v of all neurons in the core. The axon units 625 then generates spike messages 630 to be sent (by output unit 635) for all fanout cores of each firing neuron. The learning unit 640 updates synaptic weights using the programmed learning rules at epoch boundaries. In some implementations, the learning unit 640 may utilize learning rules based on spike time dependent plasticity (STDP) (e.g., nearest-neighbor STDP). In another example, a learning rule may be implemented where learning rules rely on temporal correlations in spiking activity over a range of timescales, which means more than just the most recent spike times are maintained by the neuromorphic core. In one example, on every learning epoch, a synapse may be updated whenever the appropriate pre- or post-synaptic conditions are satisfied. A set of microcode operations associated with the synapse determines the functional form of one or more of a set of transformations to apply to the synapse's state variables. The rules may be specified in sum-of-products form, among other example implementations.

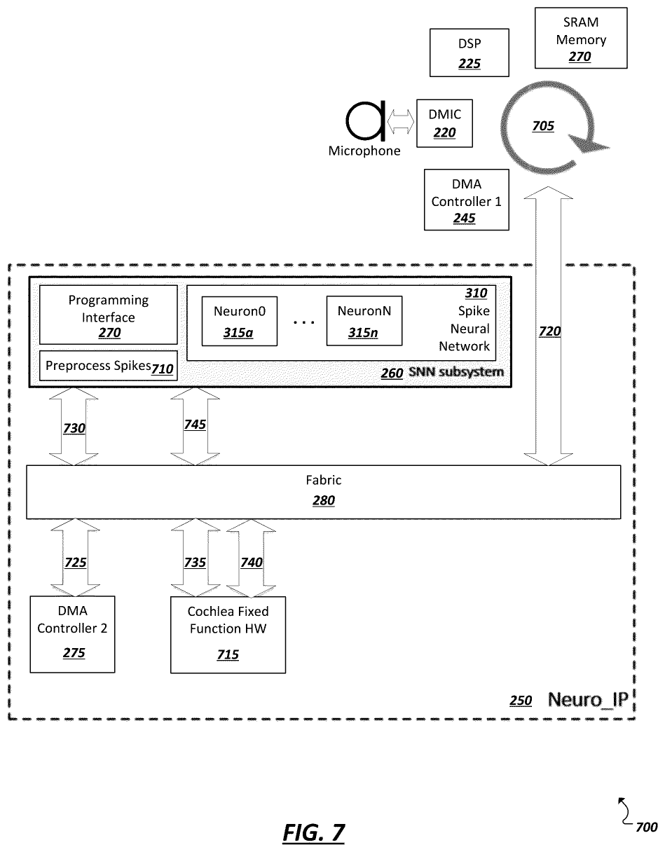

Turning to FIG. 7, a simplified block diagram 700 is illustrated to show operation of an example neuromorphic acoustic processing subsystem (e.g., 250) within a computing device, which also includes a DSP (e.g., 225) or other processing element. The computing device may include an interconnect 705 to enable communications between the elements of the computing device, including DSP 225, memory 270, a DMA controller 245, and the neuromorphic acoustic processing subsystem 250 (e.g., implemented as a separate chip or IP block). A digital microphone 220 of the device may produce digital audio signal data for further processing (based on sounds picked up by the microphone 220 with the surrounding environment. The DMA controller 245 of the computing device may be programmed (e.g., in certain conditions) to copy audio signal data at each programmed time interval (e.g., on a frame-by-frame basis) from the microphone to memory 270 (e.g., SRAM). The memory 270 may be utilized to store additional information for use to perform acoustic recognition tasks using neuromorphic acoustic subsystem 250, including model parameters for the SNN (e.g., to be communicated to or accessed by the neuromorphic acoustic subsystem 250), audio digital samples (e.g., corresponding to the microphone data), registers to record outputs of the neuromorphic acoustic subsystem 250, spike information, etc.

In some implementations, only a portion of the overall acoustic recognition functionality and related tasks are to be performed using neuromorphic acoustic subsystem 250. For instance, neuromorphic acoustic subsystem 250 may be responsible for processing initial or lightweight acoustic recognition tasks, acoustic recognition tasks while the DSP 225 or other subsystems of the computing device are disabled or in a low power mode, among other examples. Remaining acoustic recognition tasks may be performed outside of the neuromorphic acoustic subsystem 250, for instance, by the DSP 225 using conventional acoustic processing techniques, among other example implementations. In addition to performing other acoustic processing tasks, DSP 225 (or another processor within the computing device) may be responsible for configuring and setting up audio processing pipelines involving neuromorphic acoustic subsystem 250. For instance, prior to entering a sleep or inactive state, the DSP 225 may program the microphone 220 and/or DMA controller 245 to cause microphone data to be written to memory 270 while the DSP 225 is inactive. The DSP 225 may further program neuromorphic acoustic subsystem 250 (e.g., via programming interface 270) to define or identify one or more SNN model configurations to be applied by the neuromorphic acoustic subsystem 250 (at SNN subsystem 260), as well as select spike generator logic (e.g., preprocess spike generator 710 or cochlea fixed function hardware 715, etc.) for use by the neuromorphic acoustic subsystem 250, and the DMA controller 275 of the neuromorphic acoustic subsystem 250, such that data flow and processing by the neuromorphic acoustic subsystem 250 is appropriate configured. The DSP 225 may then enter a sleep or other inactive mode (or address other workloads) until an interrupt or other trigger is identified (e.g., corresponding to outputs generated by the neuromorphic acoustic subsystem 250), among other example implementations.

Continuing with the example of FIG. 7, an example neuromorphic acoustic subsystem 250 may include an interconnect fabric (e.g., an AXI fabric) may be provided within the neuromorphic acoustic subsystem 250 to enable point-to-point communications and transactions between the various components (e.g., 260, 275, 715, etc.) of the neuromorphic acoustic subsystem 250. A DMA controller 275 of the neuromorphic acoustic subsystem 250 may be implemented as a two-channel DMA to copy audio samples (e.g., 725) of microphone data from memory 270 directly (at 730) to SNN subsystem 260 (e.g., for use by preprocess spike generator 710) or (at 735) cochlea fixed function HW 715 (e.g., on a frame-by-frame basis). Spike generation hardware (e.g., 710, 715) may implement respective algorithms to convert the audio signal data included in a sample (e.g., 730, 735) into a respective set or train of one or more spike signals or messages (e.g., 740) to be input (e.g., via 745) to an SNN 310 implemented by the SNN subsystem 260. The respective neuron cores 315a-n implementing the SNN 310 may operate upon the input spikes (and generate follow spikes that propagate within the SNN 310) to generate an output (communicated via 745) that includes one or more, or zero, output spikes. In some implementations, data describing the output of the SNN may be generated by the neuromorphic acoustic subsystem 250 and output (via 720) back to memory 270 (e.g., written to a register associated with triggering a wake event or interrupt) using DMA control 275, among other examples.

Spike generator logic (e.g., 710, 715) of neuromorphic acoustic processing subsystem 250 may function to convert digital audio samples into spikes messages. In this manner, audio samples may be converted into spikes without the assistance of any element (e.g., the DSP 225) outside the neuromorphic acoustic processing subsystem 250. In such instances, the internal spike generation circuitry (e.g., 710, 715) of the neuromorphic acoustic processing subsystem 250 may be utilized when other subsystems (e.g., the DEP) are in low power mode or disabled. For instance, the neuromorphic acoustic processing subsystem 250 may be programmed or configured (e.g., by the DSP before transitioning to a sleep state) such that audio sample data written to memory 270 by DMA controller 3245 is automatically copied by the DMA control 275 to one of the internal spike generators of the neuromorphic acoustic processing subsystem 250. For instance, microphone audio data stored inside SRAM may be transferred directly to cochlea fixed function block 715 by DMA controller 275.

In one example, a cochlea fixed function block 715 may implement a spike generator through hardware configured to model the biological function of a human (or animal) ear and auditory system. For instance, the cochlea fixed function block 715 block may accept, as an input, data representing an audio signal (collected by the microphone 220) and react to various frequency components of the signal based on how acoustic pressure waves in the biological cochlea would be translated into biological nerve firings. For instance, in one example, hardware circuitry (e.g., a field-programmable gate array (FPGA)) may implement a neuromorphic auditory sensor (NAS) completely in the spike domain. The NAS may transform information in an acoustic wave (e.g., as described in microphone data retrieved from memory 270) into an equivalent spike rated representation. In one example, the cochlea fixed function block 715 uses a set of cascade spike-based low-pass filters (SLPFs) (e.g., based on Lyon's model of the biological cochlea). The cochlea fixed function block 715 may processes information directly encoded as spikes using pulse frequency modulation (PFM), decomposing PFM audio into a set of frequency bands, and propagating that information by means of an address-event representation (AER) interface. This allows real-time event-by-event audio processing (without the need for buffering), using neuromorphic processing layers.

Additionally, parameters of the cochlea fixed function block 715 may be configurable and programmable (e.g., using a programming interface of the neuromorphic acoustic processing subsystem 250) to enable the NAS to be tuned to implement audio frequency decomposers with different features, facilitating custom configured synthesis implementations. For instance, features such as the number of frequency channels handled, stop frequency, working frequency for filters, etc. may be configured and tuned within the NAS. For instance, the cochlea fixed function block 715 may be programmatically configured with a particular number of channels (e.g., 128) and stop frequency set (e.g., to 8 kHz) to cutoff frequencies above the stop frequency and limit the processing bandwidth needed to generate a spike train using the cochlea fixed function block 715, among other examples. Indeed, based on input digital data fetched by the cochlea fixed function block 715, output spikes are generated at a configured frequency rate manner for every frequency channel defined in the signal. In some implementations, the spike generation rate may also or alternatively be controlled or adjusted using an internal clock divider, among other example implementations.

The NAS implemented by the cochlea fixed function block 715, unlike digital cochleae that decompose audio signals using classical digital signal processing techniques, may utilize a neuromorphic model that processes information directly encoded as spikes using pulse frequency modulation and provide a set of frequency-decomposed audio information using an address-event representation interface. The NAS may embody a parallel computational system to the SNN subsystem 260, with spikes flowing between dedicated spike processing hardware units without sharing or multiplexing any computational elements. In such instances, the cochlea fixed function block 715 may operate with low clock frequencies (e.g., 27 MHz) and with low power consumption (e.g., below 30 mW). Further, spike-based building blocks do not require dedicated resources, such as floating- or fixed-point multipliers, among other example advantages. In one example, the cochlea fixed function block may be implemented based on a VHSIC Hardware Description Language (VHDL)-based NAS (e.g., OpenNAS), among other example implementations.

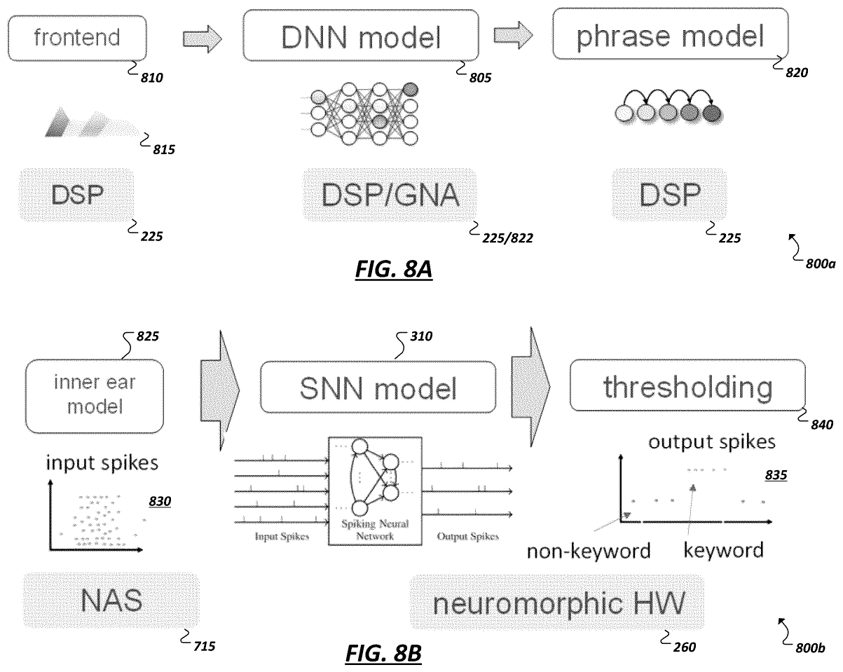

An SNN implemented by an SNN subsystem of a neuromorphic acoustic processing system may be configured for use in determining inferences relating to one or multiple different acoustic recognition tasks and applications. For instance, in response to receiving an input spike train (e.g., as generated by preprocess spike generator 710 or cochlea fixed function block 715) the SNN may generate one or a set of output spikes, which may be interpreted as inferences corresponding to one or more acoustic recognition tasks. In FIGS. 8A-8B, simplified block diagrams 800a-b are shown illustrating alternative approaches to autonomously performing a wake-on-voice or keyword spotting acoustic recognition task at a computing device. For instance, FIG. 8A illustrates a solution based on a DNN model 805 executed by or in coordination with a DSP 225. Frontend processing 810 of audio data may be performed by the DSP to convert audio signal data from a microphone into a feature set usable as an input by a DNN model 805. For instance, the DSP may compute an MFCC frontend 815 for the audio signal. The DNN model 805 may be implemented and executed using the DSP 225 or specialized DNN processing hardware 822 (e.g., an ANN accelerator) to generate a phrase model 820 output tensor. This phrase model 820 may be additionally processed by a DSP 225 to determine whether the audio signal input is inferred to include a voice prompt or keyword (e.g., and trigger additional activity or functionality of the device).

Alternatively, as illustrated in the example of FIG. 8B, the same or similar wake-on-voice or keyword spotting acoustic recognition task may be offloaded to a neuromorphic acoustic processing subsystem without the need for similar processing by the DSP 225 (enabling power savings and/or to free up bandwidth of the DSP for other activities). In the example of FIG. 8B, an inner ear model 825, implemented by a NAS (e.g., of a cochlea fixed function block 715), may take the same audio signal data from a microphone and convert the signal into a set of input spikes 830 directly at the neuromorphic acoustic processing subsystem. The input spikes 830 may be input to a SNN model 310 implemented on neuromorphic hardware 260 of the acoustic processing subsystem to generate a set of output spikes 835 based on the input spikes 830. Additional hardware circuitry may be provided on the neuromorphic acoustic processing subsystem to perform thresholding 840 of the output spikes 835 to compare the output spikes against one or more simple thresholds or patterns to generate a result of the acoustic recognition task. For instance, in one example, the threshold logic of the neuromorphic acoustic processing subsystem, for an example wake-on-voice or keyword spotting task, may generate one of two outputs: true (e.g., voice present or keyword detected) or false (e.g., reject the sound). In one implementation, threshold logic may be implemented as a classification backend trained to accumulate spikes output by the SNN 310 and compare the difference to a predefined threshold. When the threshold is exceeded, a signal may be sent (e.g., an interrupt message, a write request to a particular register, etc.) from the neuromorphic acoustic processing subsystem to one or more other elements of the device. For instance, in response to a message that a voice prompt or keyword was detected at the neuromorphic acoustic processing subsystem, a DSP, host, or other hardware may be woken up and the detection further processed (e.g., in firmware or software).

In one example implementation, performance of a DNN-based wake-on-voice task performed using a DSP is compared against performance of a similar task using a neuromorphic acoustic processing subsystem (e.g., without parallel operation by a DSP). Table 1 summarizes results of such an example comparison. In the cases of the DNN-based approach, the DSP may be a prime contributor to the power usage. For instance, the infrastructure, shim and algorithm are estimated to consume 10 mW in a podcast scenario. By applying an end-to-end neuromorphic solution, such described in the examples herein, the DSP power can be reduced to less than 0.1 mW as the DSP will only be woken up after the neuromorphic acoustic processing subsystem detects a keyword. In this example, the overall power saving in using a neuromorphic acoustic processing subsystem to perform wake-on-voice may be estimated to be 3× compared to a DSP-driven inference. In the performance of more complex acoustic recognition tasks, an end-to-end neuromorphic solution (e.g., according to the principles discussed herein) may yield even more impressive power saving (e.g., in an inference-heavy dynamic noise suppression algorithm where power savings from an end-to-end neuromorphic solution may be much higher (e.g., 10×)).

TABLE 1
Comparison of Example Performance of a Wake-on-Voice Task

| | WAKE ON VOICE ALGORITHM | | |
|---|---|---|---|
| | | DSP DNN | Neuromorphic |
| Measurement | | implementation | end-to-end |

| | | |
|---|---|---|
| Model size | 135k | 3.5k |
| (# parameters) | | |

| | | | | |
|---|---|---|---|---|
| Inference Power | 0.108 | mW | 0.006 | mW |
| DSP Power | 10 | mW | <0.1 | mW |
| DMIC Power | 4.5 | mW | 4.5 | mW |

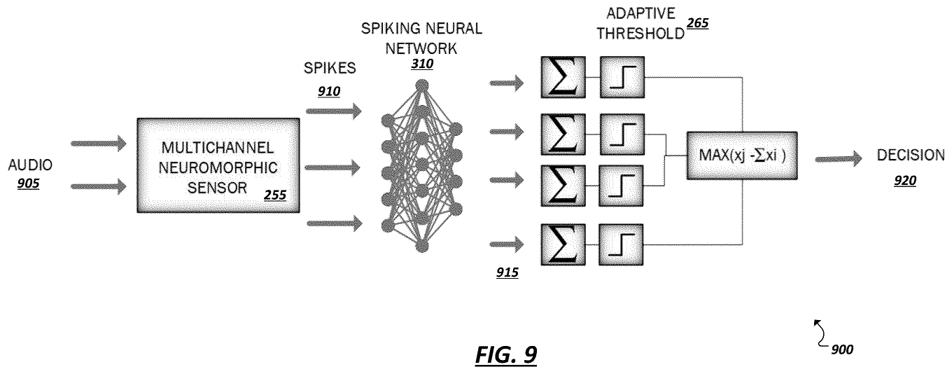

Turning to FIG. 9, simplified block diagram 900 illustrates another example implementation of an acoustic recognition task using an example neuromorphic acoustic processing subsystem, such as discussed above. In this example, an acoustic context awareness (ACA) task is to be performed, with an example SNN 310 receiving a set of input spikes 910 (e.g., generated at the neuromorphic acoustic processing subsystem by a spike generator 255 (e.g., using multichannel neuromorphic sensor) based on received audio 905 and generating output spikes 915 based on the input spike train. The output spikes 915 may be generated associated with multiple different classes or classifications of the sound input. The output spikes may be fed to thresholding hardware 265 implementing a multiclass neuromorphic backend. For each class of recognized sound, the output spikes may be accumulated and compared to a defined threshold. For instance, the SNN 310 may generate a high percentage of output spikes that correlate with an inference that the audio signal embodies sounds relating to a particular one of potentially multiple different contexts, which may be detected using the SNN (e.g., wind, a dog barking, a baby crying, a car moving, etc.). As output spikes or a combination of output spike are accumulated that corroborate that the sounds are in fact sounds associated with the particular context, thresholding circuitry may detect that a defined threshold is reached. When the threshold corresponding to a particular class or context is reached or exceeded, an output signal may be generated by the neuromorphic acoustic processing subsystem to indicate the detected context 920 to one or more other blocks or components of the device, among other examples. [INVENTORS: Correct?]

While the examples of FIGS. 8B and 9 describe the use of an example neuromorphic acoustic processing subsystem to perform relatively simple acoustic recognition tasks (e.g., in situations where it may be advantageous to utilize the neuromorphic acoustic processing subsystem as a lower power alternative to other hardware on a device (e.g., to save power or preserve low power state of the of the other hardware)), it should be appreciated that an SNN of the neuromorphic acoustic processing subsystem may also be configured to perform more complex recognition tasks. Indeed, the neuromorphic acoustic processing subsystem may also be utilized in “full power” conditions and may also work in combination with a DSP, host processor, accelerator, or other hardware to perform robust acoustic recognition workloads. For instance, the neuromorphic acoustic processing subsystem may receive spike trains generated by a DSP or other hardware of the device (e.g., in lieu of using its internal spike generator hardware) and perform inferences on these spike train inputs. As another example, output spike trains generated by the neuromorphic acoustic processing subsystem's SNN may be fed to a DSP or other hardware or firmware logic for further processing (e.g., to further interpret or otherwise use the output spikes), among other example implementations.

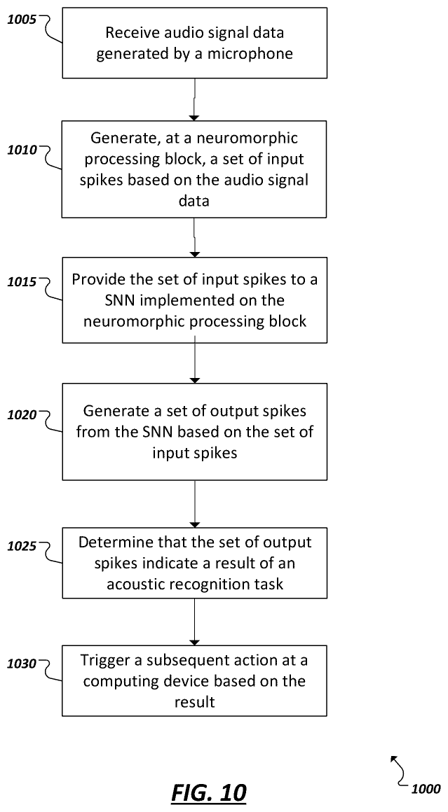

FIG. 10 is a simplified flowchart 1000 illustrating an example technique for using neuromorphic acoustic processing device to perform acoustic recognition tasks. For instance, spike generation circuitry resident in hardware of the neuromorphic acoustic processing device may generate 1005 a set of input spikes from a portion of audio generated by a microphone on a device. The input spikes may be passed 1010 as inputs to a SNN implemented in neuromorphic computing hardware of the neuromorphic acoustic processing device. The SNN may be trained and configured to generate 1020 output spikes corresponding to particular noises (e.g., acoustic frequency patterns) appearing in the audio data generated by the microphone. The output spikes may be processed (e.g., accumulated over a particular time frame) to determine that a threshold has been reached and determine 1025 that the output spikes (e.g., a repeating or most frequent single output spike or particular combination of output spikes) correspond to the detection of a targeted sound or collection of sounds (e.g., a noise, a word or phrase, etc.). The detection of the targeted sound(s) may embody the result of an acoustic recognition task (e.g., a wake-on-voice task, a keyword spotting task, an acoustic context awareness task, an acoustic event detection task, an instant speech detection tasks, or a dynamic noise suppression task) and data indicating the result may be communicated (e.g., via a message, DMA write to a register, etc.) to other components of a computing device to cause subsequent actions (e.g., waking one or more other components, triggering additional processing (e.g., by the other components), triggering the use of application logic, triggering a transaction with a cloud-based audio recognition service, etc.) to be performed relating to the microphone audio at the computing device.

While some of the systems and solution described and illustrated herein have been described as containing or being associated with a plurality of elements, not all elements explicitly illustrated or described may be utilized in each alternative implementation of the present disclosure. Additionally, one or more of the elements described herein may be located external to a system, while in other instances, certain elements may be included within or as a portion of one or more of the other described elements, as well as other elements not described in the illustrated implementation. Further, certain elements may be combined with other components, as well as used for alternative or additional purposes in addition to those purposes described herein.

Further, it should be appreciated that the examples presented above are non-limiting examples provided merely for purposes of illustrating certain principles and features and not necessarily limiting or constraining the potential embodiments of the concepts described herein. For instance, a variety of different embodiments can be realized utilizing various combinations of the features and components described herein, including combinations realized through the various implementations of components described herein. Other implementations, features, and details should be appreciated from the contents of this Specification.

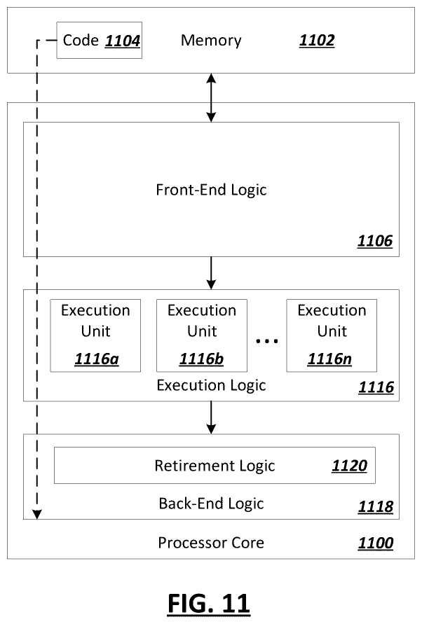

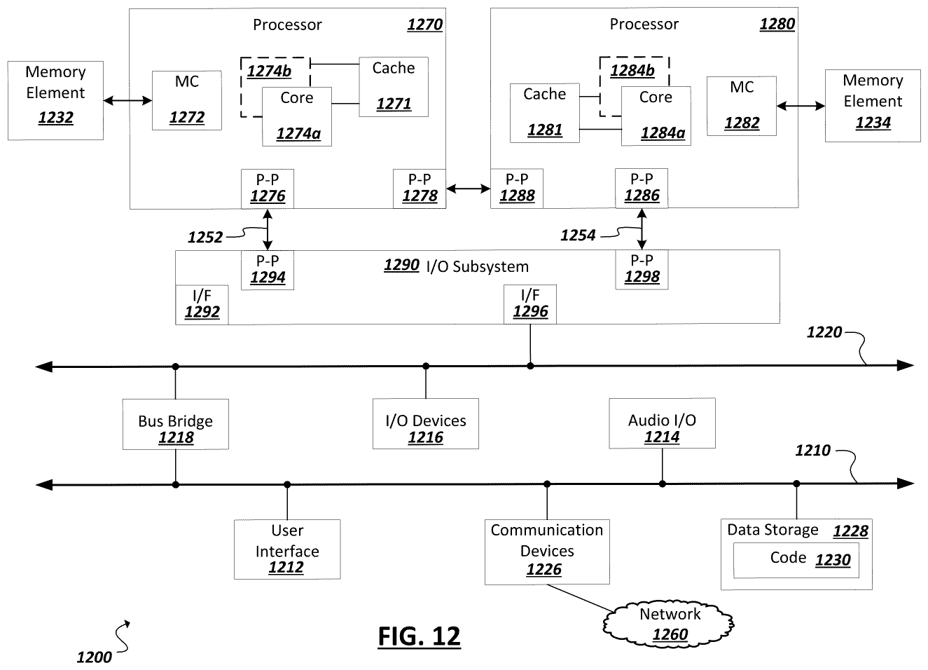

FIGS. 11-12 are block diagrams of exemplary computer architectures that may be used in accordance with embodiments disclosed herein, including a neuromorphic processing block, DSP, host processor, etc. Other computer architecture designs known in the art for processors and computing systems may also be used. Generally, suitable computer architectures for embodiments disclosed herein can include, but are not limited to, configurations illustrated in FIGS. 11-12.

FIG. 11 is an example illustration of a processor according to an embodiment. Processor 1100 is an example of a type of hardware device that can be used in connection with the implementations above. Processor 1100 may be any type of processor, such as a microprocessor, an embedded processor, a digital signal processor (DSP), a network processor, a multi-core processor, a single core processor, or other device to execute code. Although only one processor 1100 is illustrated in FIG. 11, a processing element may alternatively include more than one of processor 1100 illustrated in FIG. 11. Processor 1100 may be a single-threaded core or, for at least one embodiment, the processor 1100 may be multi-threaded in that it may include more than one hardware thread context (or “logical processor”) per core.

FIG. 11 also illustrates a memory 1102 coupled to processor 1100 in accordance with an embodiment. Memory 1102 may be any of a wide variety of memories (including various layers of memory hierarchy) as are known or otherwise available to those of skill in the art. Such memory elements can include, but are not limited to, random access memory (RAM), read only memory (ROM), logic blocks of a field programmable gate array (FPGA), erasable programmable read only memory (EPROM), and electrically erasable programmable ROM (EEPROM).

Processor 1100 can execute any type of instructions associated with algorithms, processes, or operations detailed herein. Generally, processor 1100 can transform an element or an article (e.g., data) from one state or thing to another state or thing.

Code 1104, which may be one or more instructions to be executed by processor 1100, may be stored in memory 1102, or may be stored in software, hardware, firmware, or any suitable combination thereof, or in any other internal or external component, device, element, or object where appropriate and based on particular needs. In one example, processor 1100 can follow a program sequence of instructions indicated by code 1104. Each instruction enters a front-end logic 1106 and is processed by one or more decoders 1108. The decoder may generate, as its output, a micro-operation such as a fixed width micro operation in a predefined format, or may generate other instructions, microinstructions, or control signals that reflect the original code instruction. Front-end logic 1106 also includes register renaming logic 1110 and scheduling logic 1112, which generally allocates resources and queue the operation corresponding to the instruction for execution.

Processor 1100 can also include execution logic 1114 having a set of execution units 1116a, 1116b, 1116n, etc. Some embodiments may include a number of execution units dedicated to specific functions or sets of functions. Other embodiments may include only one execution unit or one execution unit that can perform a particular function. Execution logic 1114 performs the operations specified by code instructions.

After completion of execution of the operations specified by the code instructions, back-end logic 1118 can retire the instructions of code 1104. In one embodiment, processor 1100 allows out of order execution but requires in order retirement of instructions. Retirement logic 1120 may take a variety of known forms (e.g., re-order buffers or the like). In this manner, processor 1100 is transformed during execution of code 1104, at least in terms of the output generated by the decoder, hardware registers and tables utilized by register renaming logic 1110, and any registers (not shown) modified by execution logic 1114.

Although not shown in FIG. 11, a processing element may include other elements on a chip with processor 1100. For example, a processing element may include memory control logic along with processor 1100. The processing element may include I/O control logic and/or may include I/O control logic integrated with memory control logic. The processing element may also include one or more caches. In some embodiments, non-volatile memory (such as flash memory or fuses) may also be included on the chip with processor 1100.

FIG. 12 illustrates a computing system 1200 that is arranged in a point-to-point (PtP) configuration according to an embodiment. In particular, FIG. 12 shows a system where processors, memory, and input/output devices are interconnected by a number of point-to-point interfaces. Generally, one or more of the computing systems described herein may be configured in the same or similar manner as computing system 1100.

Processors 1270 and 1280 may also each include integrated memory controller logic (MC) 1272 and 1282 to communicate with memory elements 1232 and 1234. In alternative embodiments, memory controller logic 1272 and 1282 may be discrete logic separate from processors 1270 and 1280. Memory elements 1232 and/or 1234 may store various data to be used by processors 1270 and 1280 in achieving operations and functionality outlined herein.

Processors 1270 and 1280 may be any type of processor, such as those discussed in connection with other figures. Processors 1270 and 1280 may exchange data via a point-to-point (PtP) interface 1250 using point-to-point interface circuits 1278 and 1288, respectively. Processors 1270 and 1280 may each exchange data with a chipset 1290 via individual point-to-point interfaces 1252 and 1254 using point-to-point interface circuits 1276, 1286, 1294, and 1298. Chipset 1290 may also exchange data with a co-processor 1238, such as a high-performance graphics circuit, machine learning accelerator, or other co-processor 1238, via an interface 1239, which could be a PtP interface circuit. In alternative embodiments, any or all of the PtP links illustrated in FIG. 12 could be implemented as a multi-drop bus rather than a PtP link.

Chipset 1290 may be in communication with a bus 1220 via an interface circuit 1296. Bus 1220 may have one or more devices that communicate over it, such as a bus bridge 1218 and I/O devices 1216. Via a bus 1210, bus bridge 1218 may be in communication with other devices such as a user interface 1212 (such as a keyboard, mouse, touchscreen, or other input devices), communication devices 1226 (such as modems, network interface devices, or other types of communication devices that may communicate through a computer network 1260), audio I/O devices 1214, and/or a data storage device 1228. Data storage device 1228 may store code 1230, which may be executed by processors 1270 and/or 1280. In alternative embodiments, any portions of the bus architectures could be implemented with one or more PtP links.

The computer system depicted in FIG. 12 is a schematic illustration of an embodiment of a computing system that may be utilized to implement various embodiments discussed herein. It will be appreciated that various components of the system depicted in FIG. 12 may be combined in a system-on-a-chip (SoC) architecture or in any other suitable configuration capable of achieving the functionality and features of examples and implementations provided herein.

While some of the systems and solutions described and illustrated herein have been described as containing or being associated with a plurality of elements, not all elements explicitly illustrated or described may be utilized in each alternative implementation of the present disclosure. Additionally, one or more of the elements described herein may be located external to a system, while in other instances, certain elements may be included within or as a portion of one or more of the other described elements, as well as other elements not described in the illustrated implementation. Further, certain elements may be combined with other components, as well as used for alternative or additional purposes in addition to those purposes described herein.

Further, it should be appreciated that the examples presented above are non-limiting examples provided merely for purposes of illustrating certain principles and features and not necessarily limiting or constraining the potential embodiments of the concepts described herein. For instance, a variety of different embodiments can be realized utilizing various combinations of the features and components described herein, including combinations realized through the various implementations of components described herein. Other implementations, features, and details should be appreciated from the contents of this Specification.

Although this disclosure has been described in terms of certain implementations and generally associated methods, alterations and permutations of these implementations and methods will be apparent to those skilled in the art. For example, the actions described herein can be performed in a different order than as described and still achieve the desirable results. As one example, the processes depicted in the accompanying figures do not necessarily require the particular order shown, or sequential order, to achieve the desired results. In certain implementations, multitasking and parallel processing may be advantageous. Additionally, other user interface layouts and functionality can be supported. Other variations are within the scope of the following claims.

While this specification contains many specific implementation details, these should not be construed as limitations on the scope of any inventions or of what may be claimed, but rather as descriptions of features specific to particular embodiments of particular inventions. Certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the embodiments described above should not be understood as requiring such separation in all embodiments, and it should be understood that the described program components and systems can generally be integrated together in a single software product or packaged into multiple software products.

The following examples pertain to embodiments in accordance with this Specification. Example 1 is an apparatus including: a spike generator including hardware to generate a set of input spikes based on acoustic signal data generated by a microphone of a computing device; a neuromorphic compute block to: implement a spiking neural network (SNN); receive the set of input spikes as an input to the SNN; generate a set of output spikes from the SNN based on the input; threshold logic to: determine that the set of output spikes correspond to a result of an acoustic recognition task; and generate result data to identify the result.

Example 2 includes the subject matter of claim 1, further including direct memory access (DMA) circuitry to: retrieve the acoustic signal data from memory of the computing device; provide the acoustic signal data to the spike generator; and copy the result data to the memory.

Example 3 includes the subject matter of claim 2, further including an interconnect fabric to enable point-to-point communication between the DMA circuitry, the spike generator, and the neuromorphic compute block.

Example 4 includes the subject matter of any one of claims 1-3, where the computing device further includes a digital signal processor (DSP) to perform at least one other acoustic recognition task.

Example 5 includes the subject matter of claim 4, where the DSP is in an inactive state when the acoustic recognition task is performed by the apparatus.

Example 6 includes the subject matter of claim 5, where the result is to trigger activation of the DSP.

Example 7 includes the subject matter of claim 4, where the apparatus is a neuromorphic acoustic processing block and is coupled to the DSP by an interconnect.

Example 8 includes the subject matter of any one of claims 1-7, where the spike generator includes a cochlear fixed function block to model function of a biological ear.

Example 9 includes the subject matter of any one of claims 1-8, where the acoustic recognition task includes one of a wake-on-voice task, a keyword spotting task, an acoustic context awareness task, an acoustic event detection task, an instant speech detection tasks, or a dynamic noise suppression task.

Example 10 includes the subject matter of any one of claims 1-9, where the computing device includes one of a laptop computing device, a smartphone device, a home monitor device, or a personal digital assistant device.

Example 11 includes the subject matter of any one of claims 1-10, where the neuromorphic compute block includes a network of interconnected neuromorphic cores, each neuromorphic cores core is to implement a subset of a plurality of neurons in the SNN, and the neuromorphic compute block includes a set of internal routers to route spike messages between the plurality of neurons during operation of the SNN.

Example 12 is a method including: receiving a digital audio signal generated by a microphone; converting, using computing hardware, the digital audio signal into a train of input spikes; sending the train of input spikes to a spiking neural network (SNN) implemented in a neuromorphic computing device; generating a set of output spikes as an output of the SNN based on the train of input spikes; summing the set of output spikes to determine that a particular threshold is met; and generating a result of an acoustic recognition task based on meeting the particular threshold.

Example 13 includes the subject matter of claim 12, further including offloading the acoustic recognition task from another processing device while the other processing device is in a low power mode.

Example 14 includes the subject matter of claim 13, further including receiving a programming input to configure: the SNN to perform an inference related to the acoustic recognition task; a first direct memory access (DMA) controller to copy the digital audio signal to memory while the other processing device is in the low power mode; and a second direct memory access (DMA) controller to retrieve the digital audio signal from the memory for the computing hardware while the other processing device is in the low power mode.

Example 15 includes the subject matter of claim 14, further including: waking the other processing device from the low power state based on the result; and performing additional processing of audio data using the other processing device based on the result.

Example 16 includes the subject matter of claim 14, where one or more direct memory access controllers copy audio data including the digital audio signal from the microphone to memory, and retrieve the audio data from memory to provide the audio data to the computing hardware.

Example 17 includes the subject matter of any one of claims 13-16, where the other processing device includes a digital signal processor.

Example 18 includes the subject matter of any one of claims 12-17, where the computing hardware includes a neuromorphic acoustic sensor (NAS).

Example 19 includes the subject matter of claim 18, where the NAS includes a cochlear fixed function block to model function of a biological ear.

Example 20 includes the subject matter of any one of claims 12-19, where the acoustic recognition task includes one of a wake-on-voice task, a keyword spotting task, an acoustic context awareness task, an acoustic event detection task, an instant speech detection tasks, or a dynamic noise suppression task.

Example 21 includes the subject matter of any one of claims 12-20, where the microphone is mounted on a computing device including one of a laptop computing device, a smartphone device, a home monitor device, or a personal digital assistant device.

Example 22 includes the subject matter of any one of claims 12-21, where the SNN is implemented by a neuromorphic compute block including a network of interconnected neuromorphic cores, each neuromorphic cores core is to implement a subset of a plurality of neurons in the SNN, and the neuromorphic compute block includes a set of internal routers to route spike messages between the plurality of neurons during operation of the SNN.

Example 23 is a system including means to perform the method of any one of claims 12-

Example 24 is a system including: a processor; a memory; a microphone to generate digital acoustic data; and a neuromorphic processing block including: a spike generator including circuitry to: receive the digital acoustic data; and generate a set of input spikes based on the digital acoustic data; a neuromorphic compute block coupled to: receive the set of input spikes from the spike generator; provide the set of input spikes to a spiking neural network implemented in a network of neuromorphic cores of the neuromorphic compute block; and generate output spikes based on the set of input spikes; and threshold detection circuitry to determine, from the output spikes, that the output spikes indicate a particular result for an acoustic recognition task.

Example 25 includes the subject matter of claim 24, further including: a first direct memory access (DMA) controller external to the neuromorphic processing block to copy the digital acoustic data to the memory; and a second DMA controller in the neuromorphic processing block to: access the digital acoustic data from the memory; provide the digital acoustic data to the spike generator; and write the particular result to the memory.

Example 26 includes the subject matter of claim 25, where the neuromorphic processing block includes a programming interface to receive configuration information to configure the SNN to perform inferences in support of the acoustic recognition task and configure the first DMA controller and the second DMA controller to feed the digital acoustic data from the microphone to the spike generator to initiate performance of the acoustic recognition task by the neuromorphic processing block.

Example 27 includes the subject matter of claim 26, where performance of the acoustic recognition task by the neuromorphic processing block is initiated based on unavailability of the processor.

Example 28 includes the subject matter of claim 27, where the processor is unavailable based on entry to a low power or inactive state.

Example 29 includes the subject matter of claim 27, where the processor is used to perform the acoustic recognition task when available.

Example 30 includes the subject matter of any one of claims 24-29, further including digital signal processing logic executable by the processor to: identify the particular result; and perform further acoustic recognition tasks based on acoustic data generated by the microphone and the particular result.

Example 31 includes the subject matter of any one of claims 24-30, where the processor includes a digital signal processor (DSP), the DSP is to perform the acoustic recognition task in a full power mode, and the neuromorphic processing block is to perform the acoustic recognition task when the DSP is in a low power mode.

Example 32 includes the subject matter of any one of claims 24-31, including a personal computing device to include the processor, memory, microphone, and neuromorphic processing block.

Example 33 includes the subject matter of any one of claims 24-32, where the spike generator includes neuromorphic acoustic sensor circuitry.

Example 34 includes the subject matter of claim 33, where the neuromorphic acoustic sensor circuitry implements a cochlear fixed function block.

Example 35 includes the subject matter of any one of claims 24-34, where the acoustic recognition task includes one of a wake-on-voice task, a keyword spotting task, an acoustic context awareness task, an acoustic event detection task, an instant speech detection tasks, or a dynamic noise suppression task

Example 36 includes the subject matter of any one of claims 24-35, where the neuromorphic compute block includes a network of interconnected neuromorphic cores, each neuromorphic cores core is to implement a subset of a plurality of neurons in the SNN, and the neuromorphic compute block includes a set of internal routers to route spike messages between the plurality of neurons during operation of the SNN.

Example 37 includes the subject matter of any one of claims 24-36, where the threshold detection circuitry determines that the output spikes indicate a particular result for an acoustic recognition task by accumulating the output spikes over a range and determines whether a sum of the output spikes meets or exceeds the threshold.

Example 38 includes the subject matter of any one of claims 24-37, where the output spikes include a plurality of types of output spikes and the particular result is determined based on identifying that a combination of two or more types of output spikes meet or exceeds the threshold.

Thus, particular embodiments of the subject matter have been described. Other embodiments are within the scope of the following claims. In some cases, the actions recited in the claims can be performed in a different order and still achieve desirable results. In addition, the processes depicted in the accompanying figures do not necessarily require the particular order shown, or sequential order, to achieve desirable results.

What is claimed is:

1. An apparatus comprising:
a spike generator comprising hardware to generate a set of input spikes based on acoustic signal data generated by a microphone of a computing device;
a neuromorphic compute block to:
implement a spiking neural network (SNN);
receive the set of input spikes as an input to the SNN;
generate a set of output spikes from the SNN based on the input;
threshold logic to:
determine that the set of output spikes correspond to a result of an acoustic recognition task; and
generate result data to identify the result.

2. The apparatus of claim 1, further comprising direct memory access (DMA) circuitry to:
retrieve the acoustic signal data from memory of the computing device;
provide the acoustic signal data to the spike generator; and
copy the result data to the memory.

3. The apparatus of claim 2, further comprising an interconnect fabric to enable point-to-point communication between the DMA circuitry, the spike generator, and the neuromorphic compute block.

4. The apparatus of claim 1, wherein the computing device further comprises a digital signal processor (DSP) to perform at least one other acoustic recognition task.

5. The apparatus of claim 4, wherein the DSP is in an inactive state when the acoustic recognition task is performed by the apparatus.

6. The apparatus of claim 5, wherein the result is to trigger activation of the DSP.

7. The apparatus of claim 4, wherein the apparatus is a neuromorphic acoustic processing block and is coupled to the DSP by an interconnect.

8. The apparatus of claim 1, wherein the spike generator comprises a cochlear fixed function block to model function of a biological ear.

9. The apparatus of claim 1, wherein the acoustic recognition task comprises one of a wake-on-voice task, a keyword spotting task, an acoustic context awareness task, an acoustic event detection task, an instant speech detection tasks, or a dynamic noise suppression task.

10. The apparatus of claim 1, wherein the computing device comprises one of a laptop computing device, a smartphone device, a home monitor device, or a personal digital assistant device.

11. The apparatus of claim 1, wherein the neuromorphic compute block comprises a network of interconnected neuromorphic cores, each neuromorphic cores core is to implement a subset of a plurality of neurons in the SNN, and the neuromorphic compute block comprises a set of internal routers to route spike messages between the plurality of neurons during operation of the SNN.

12. A method comprising:
receiving a digital audio signal generated by a microphone;
converting, using computing hardware, the digital audio signal into a train of input spikes;
sending the train of input spikes to a spiking neural network (SNN) implemented in a neuromorphic computing device;
generating a set of output spikes as an output of the SNN based on the train of input spikes;
summing the set of output spikes to determine that a particular threshold is met; and
generating a result of an acoustic recognition task based on meeting the particular threshold.

13. The method of claim 12, further comprising offloading the acoustic recognition task from another processing device while the other processing device is in a low power mode.

14. The method of claim 13, further comprising receiving a programming input to configure:
the SNN to perform an inference related to the acoustic recognition task;
a first direct memory access (DMA) controller to copy the digital audio signal to memory while the other processing device is in the low power mode; and
a second direct memory access (DMA) controller to retrieve the digital audio signal from the memory for the computing hardware while the other processing device is in the low power mode.

15. The method of claim 14, further comprising:
waking the other processing device from the low power state based on the result; and
performing additional processing of audio data using the other processing device based on the result.

16. A system comprising:
a processor;
a memory;
a microphone to generate digital acoustic data;
a neuromorphic processing block comprising:
a spike generator comprising circuitry to:
receive the digital acoustic data; and
generate a set of input spikes based on the digital acoustic data;
a neuromorphic compute block coupled to:
receive the set of input spikes from the spike generator;
provide the set of input spikes to a spiking neural network implemented in a network of neuromorphic cores of the neuromorphic compute block;
generate output spikes based on the set of input spikes;
threshold detection circuitry to determine, from the output spikes, that the output spikes indicate a particular result for an acoustic recognition task.

17. The system of claim 16, further comprising:
a first direct memory access (DMA) controller external to the neuromorphic processing block to copy the digital acoustic data to the memory;
a DMA controller in the neuromorphic processing block to:
access the digital acoustic data from the memory;
provide the digital acoustic data to the spike generator; and
write the particular result to the memory.

18. The system of claim 16, further comprising digital signal processing logic executable by the processor to:
identify the particular result; and
perform further acoustic recognition tasks based on acoustic data generated by the microphone and the particular result.

19. The system of claim 16, wherein the processor comprises a digital signal processor (DSP), the DSP is to perform the acoustic recognition task in a full power mode, and the neuromorphic processing block is to perform the acoustic recognition task when the DSP is in a low power mode.

20. The system of claim 16, comprising a personal computing device to comprise the processor, memory, microphone, and neuromorphic processing block.
